(19) United States
(12) Patent Application Publication
(10) Pub. No.: US 2025/0383468 A1
(43) Pub. Date: Dec. 18, 2025

(54) Methods and Systems for Managing the Reconfiguration of Metal Detectors

(71) Applicant: Garrett Electronics, Inc., Garland, TX (US)

(72) Inventors: Stephen M. Novakovich, JR., Dallas, TX (US); J. Brian Head, Frisco, TX (US); Robert J. Podhrasky, Dallas, TX (US)

(73) Assignee: Garrett Electronics, Inc., Garland, TX (US)

(21) Appl. No.: 18/745,770

(22) Filed: Jun. 17, 2024

Related U.S. Application Data
(63) Continuation-in-part of application No. 18/745,691, filed on Jun. 17, 2024.

(51) Int. Cl. G01V 3/165; G01V 3/10; G06F 8/65

(52) U.S. Cl. CPC G01V 3/165; G01V 3/104; G06F 8/65

(57) ABSTRACT

Systems and techniques for managing reconfiguration of user-reconfigurable metal detectors. In embodiments, a set of available features associated with a user-reconfigurable metal detector is generated based on a set of capabilities associated with hardware components of the user-reconfigurable metal detector. A first set of features is selected from the set of available features to include in a first product profile configured to enable a first classification of metal detecting operations. A second set of features is selected to include in a second product profile configured to enable a second classification of metal detecting operations. The user-reconfigurable metal detector is configured with the first product profile. Upon receiving a request to reconfigure the user-reconfigurable metal detector, the first product profile is replaced with the second product profile.

### CROSS-REFERENCE TO RELATED APPLICATIONS

The present application is a continuation-in-part of pending and co-owned U.S. patent application Ser. No. 18/745,691, filed Jun. 17, 2024, the entirety of which is herein incorporated by reference for all purposes.

### TECHNICAL FIELD

The present disclosure relates generally to metal detectors, and more particularly to a user-reconfigurable metal detector.

### BACKGROUND

Metal detectors are amazing devices designed to detect the presence of metals within a surrounding area. They operate by generating a magnetic field and analyzing the response from metal objects when this field is disturbed. Metal detectors are widely used in various applications, including security screening at airports, construction to locate buried utilities, archaeology for uncovering historical artifacts, and by hobbyists for treasure hunting. Metal detectors can range from handheld units to larger (and often more complex) systems and are valued for their ability to locate metal objects that are not readily visible or accessible, providing a means for non-invasive exploration of various environments.

Metal detectors have been in use for over seven decades, with advancements and improvements being made in response to user requirements and emerging technologies. The development of digital metal detectors in the 1970s, which utilized microprocessors for control functions and signal processing, marked a major milestone in the evolution of metal detectors. As microprocessors became more powerful, signal processing evolved from simple measurement and display to full digital signal processing systems.

One notable feature of these digital systems was the ability to update the operation of the metal detector through software patches that were used to patch and fix bugs and secure the system. Typically, these updates are performed by the manufacturer or a repair shop.

However, the features, capabilities, and functionality of a metal detector are typically set during manufacturing, with limited upgrade capabilities available afterwards. For example, metal detectors are typically manufactured in a variety of models, each offering a distinct set of features. These features, which can range from detection capabilities to user interface design, are predetermined at the time of manufacturing. Consequently, if a customer desires to upgrade or change their metal detecting capabilities, the customer is generally forced to replace their current metal detector with a different model of the metal detector that comes with the desired features, often by purchasing the new metal detector.

For example, a customer who initially purchases an entry-level metal detector, equipped with basic features, would find themselves restricted to the functionalities offered by this entry-level metal detector. If the customer wishes to access more advanced features or a higher level of performance, the customer may have to invest in a higher-level metal detector. This upgrade process often involves a substantial additional expenditure, making it a costly endeavor for the customer.

Conversely, a customer may purchase a higher-end metal detector model, including extensive and advanced features, only to later discover that many of these features are not necessary for the customer's specific metal detecting activities. Such a customer is then left with a device that includes features that are not being utilized. Perhaps worse still, this customer may benefit from some of the advanced features but may find that they would prefer or require lower-end features for some specific aspects of the metal detecting activities. This mismatch can leave the customer with a device that is not fully aligned with their individual needs, as they are unable to combine advanced and basic features within a single model.

The deficiencies of current metal detector cause customers to face particular constraints when their metal detecting requirements span across different applications or use cases. If a customer purchases a metal detector that is specifically tailored for one application, such as relic hunting, and later decides to engage in a different metal detecting activity, like gold prospecting or law enforcement searches, the customer may be forced to purchase an entirely separate metal detector designed for that new application. This is because the features and functionalities of their existing metal detector are optimized for the initial use case and are not readily transferable or adaptable to the new application. This inflexibility not only forces customers to incur additional costs by buying multiple metal detectors for different applications but also leads to the underutilization of their original equipment.

### SUMMARY

The present disclosure achieves technical advantages as systems, methods, and computer-readable storage media with functionality for managing the reconfiguration of user-reconfigurable metal detectors. In particular embodiments, a system may be configured to manage the reconfiguration of user-reconfigurable metal detector, enabling users to modify a current product profile and/or individual features of a user-reconfigurable metal detector to suit specific metal detecting requirements and/or preferences. In embodiments, users may interact with a backend system to request a reconfiguration (e.g., modification) of the user-reconfigurable metal detector, which may include selecting features to change, add, remove, enable, or disable, or choosing a new product profile to replace the current product profile of the user-reconfigurable metal detector. Alternatively, the modifications may be requested through the interface of a local installer. Once a reconfiguration request is made, the reconfiguration request may undergo a validation process to ensure that the selected feature or product profile is authorized for the user-reconfigurable metal detector, which may depend on whether the selected feature or product profile has been purchased or is available for free. If the reconfiguration request is validated, the local installer communicates with the metal detector, sending the appropriate files, code, signals, and/or commands to execute the reconfiguration.

The present disclosure provides for a system integrated into a practical application with meaningful limitations as an integrated system with functionality for managing the reconfiguration of user-reconfigurable metal that overcomes the limitations of traditional metal detectors by providing a flexible and user-customizable platform. The reconfigurable metal detector of embodiment may be built upon a common hardware platform consisting of fixed hardware components that do not change during reconfiguration. Instead of replacing hardware components to upgrade, downgrade, or modify the functionality of the metal detector, a reconfiguration may be achieved through software by enabling or disabling features and by replacing the current product profile with a different product profile that includes a distinct set of features.

In embodiments, the system of embodiments allows users to configure and reconfigure the metal detector to support different classifications of metal detecting operations, which may represent varying levels of accuracy, power, performance, or specific metal detecting applications such as relic hunting, law enforcement, gold hunting, or coin hunting. Each classification of operations is facilitated by a product profile that encompasses a cooperative operation of a set of features selected from the set of available features associated with the reconfigurable metal detector.

In embodiments, users may be enabled to reconfigure the current product profile by adding new features to enhance the metal detector's capabilities, removing features that are no longer desired, enabling features to expand the metal detector's functionality, disabling features to streamline operations, or replacing the current product profile with a new one that better suits their evolving metal detecting requirements. This user-driven reconfiguration process can be performed by the user themselves, without the metal detector needing to be taken to a shop for reconfiguration.

As such, the present disclosure provides for a reconfigurable metal detector system that provides a cost-effective and adaptable solution, allowing users to tailor their device to their specific requirements and applications, and to evolve with their metal detecting journey. This innovative approach to metal detector design offers a sustainable and future-proof platform for users to enjoy a personalized metal detecting experience.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for metal detector configuration. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of managing the reconfiguration of user-reconfigurable metal detectors. It is a further object of the disclosure to provide a system for managing the reconfiguration of user-reconfigurable metal detectors, and a computer-based tool for managing the reconfiguration of user-reconfigurable metal detectors. These and other objects are provided by the present disclosure, including at least the following embodiments.

In one particular embodiment, a method of managing the reconfiguration of user-reconfigurable metal detectors is provided. The method includes generating a set of available features associated with a user-reconfigurable metal detector based on a set of capabilities associated with hardware components of the user-reconfigurable metal detector, selecting a first set of features from the set of available features associated with the user-reconfigurable metal detector to include in a first product profile configured to enable a first classification of metal detecting operations of the user-reconfigurable metal detector, selecting a second set of features from the set of available features associated with the user-reconfigurable metal detector to include in a second product profile configured to enable a second classification of metal detecting operations of the user-reconfigurable metal detector different from the first classification of metal detecting operations, configuring the user-reconfigurable metal detector with the first product profile, and receiving a request to reconfigure the user-reconfigurable metal detector. In embodiments, the request to reconfigure the user-reconfigurable metal detector includes a request to replace the first product profile with the second product profile. The method also includes reconfiguring the user-reconfigurable metal detector to replace the first product profile with the second product profile.

In another embodiment, a system for managing the reconfiguration of user-reconfigurable metal detectors is provided. The system comprises at least one processor and a memory operably coupled to the at least one processor and storing processor-readable code that, when executed by the at least one processor, is configured to perform operations. The operations include generating a set of available features associated with a user-reconfigurable metal detector based on a set of capabilities associated with hardware components of the user-reconfigurable metal detector, selecting a first set of features from the set of available features associated with the user-reconfigurable metal detector to include in a first product profile configured to enable a first classification of metal detecting operations of the user-reconfigurable metal detector, selecting a second set of features from the set of available features associated with the user-reconfigurable metal detector to include in a second product profile configured to enable a second classification of metal detecting operations of the user-reconfigurable metal detector different from the first classification of metal detecting operations, configuring the user-reconfigurable metal detector with the first product profile, and receiving a request to reconfigure the user-reconfigurable metal detector. In embodiments, the request to reconfigure the user-reconfigurable metal detector includes a request to replace the first product profile with the second product profile. The operations also include reconfiguring the user-reconfigurable metal detector to replace the first product profile with the second product profile.

In yet another embodiment, a computer-based tool for reconfiguring a metal detector is provided. The computer-based tool including non-transitory computer readable media having stored thereon computer code which, when executed by a processor, causes a computing device to perform operations. The operations include generating a set of available features associated with a user-reconfigurable metal detector based on a set of capabilities associated with hardware components of the user-reconfigurable metal detector, selecting a first set of features from the set of available features associated with the user-reconfigurable metal detector to include in a first product profile configured to enable a first classification of metal detecting operations of the user-reconfigurable metal detector, selecting a second set of features from the set of available features associated with the user-reconfigurable metal detector to include in a second product profile configured to enable a second classification of metal detecting operations of the user-reconfigurable metal detector different from the first classification of metal detecting operations, configuring the user-reconfigurable metal detector with the first product profile, and receiving a request to reconfigure the user-reconfigurable metal detector. In embodiments, the request to reconfigure the user-reconfigurable metal detector includes a request to replace the first product profile with the second product profile. The operations also include reconfiguring the user-reconfigurable metal detector to replace the first product profile with the second product profile.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for managing the reconfiguration of user-reconfigurable metal detectors in accordance with embodiments of the present disclosure.

FIG. 2 is a block diagram of an exemplary backend system configured with capabilities and functionality for managing reconfiguration of user-reconfigurable metal detectors in accordance with embodiments of the present disclosure.

FIG. 3 shows a high-level flow diagram of operation of a system configured for providing functionality for managing reconfiguration of user-reconfigurable metal detectors in accordance with embodiments of the present disclosure.

FIG. 4 is a flowchart illustrating operations for managing the reconfiguration of user-reconfigurable metal detectors in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

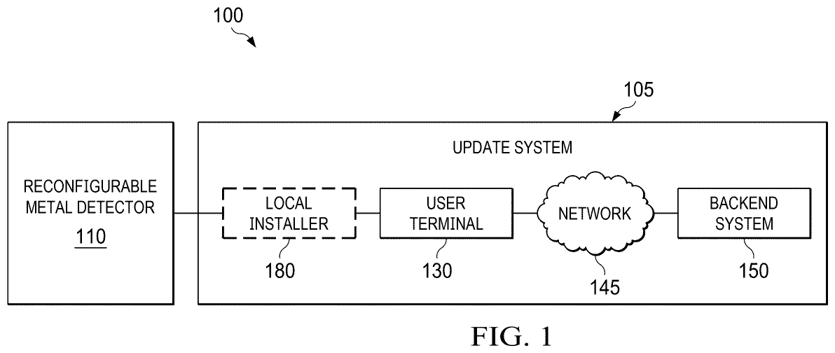

FIG. 1 is a block diagram of an exemplary system 100 configured with capabilities and functionality for managing the reconfiguration of user-reconfigurable metal detectors in accordance with embodiments of the present disclosure. As shown in FIG. 1, system 100 may include a user-reconfigurable metal detector 110, an update system 105, a user terminal 130, and a network 145. The update system 105 may include a local installer 180 and a backend system 150. These components, and their individual components, may cooperatively operate to provide functionality in accordance with the discussion herein. In particular, the system 100 may be configured to managing the reconfiguration of user-reconfigurable metal detectors, such as the reconfiguration of the user-reconfigurable metal detector 110, enabling users to modify the current product profile and/or individual features of a user-reconfigurable metal detector to suit specific metal detecting requirements and/or preferences. Users may interact with the backend system 150 to request a reconfiguration (e.g., modification) of the user-reconfigurable metal detector 110, which may include selecting features to change, add, remove, enable, or disable, or choosing a new product profile to replace the current product profile of the user-reconfigurable metal detector 110. Alternatively, the modifications may be requested through the interface of the local installer 180. Once a reconfiguration request is made, the reconfiguration request may undergo a validation process to ensure that the selected feature or product profile is authorized for the user-reconfigurable metal detector 110, which may depend on whether the selected feature or product profile has been purchased or is available for free. If the reconfiguration request is validated, the local installer 180 communicates with the metal detector 110, sending the appropriate files, code, signals, and/or commands to execute the reconfiguration.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate a user interacting with the system 100, e.g., via the network 145, to execute and leverage the features provided by the cooperative operations of the system 100. It is noted that although the user terminal 130 may be illustrated as part of update the system 105, in embodiments, the user terminal 130 may include a component that is separate and distinct from the update system 105, and as such, the illustration of the user terminal 130 as part of the update system 105 is for illustrative purposes and not by way of limitation.

In embodiments, the user terminal 130 may be configured to operate as the interface for user interaction with the reconfigurable metal detector system 100. In embodiments, the user terminal 130 may be configured to present a user interface generated by the local installer 180, which may provide a mechanism for users to initiate and manage the reconfiguration process of their metal detector. Additionally, or alternatively, the user terminal 130 may be configured to present a user interface provided by the backend system 150, which may be used by the user to access and select from a variety of features and product profiles available for their device. This dual capability provides a mechanism for interacting with the local installer 180 to make immediate changes and/or with the backend system 150 for a broader range of customization and/or reconfiguration options. In embodiments, user terminal 130 may be configured to communicate with other components of system 100.

In embodiments, the network 145 may facilitate communications between the various components of the system 100 (e.g., the user-reconfigurable metal detector 110, the backend system 150, the local installer 180, and/or the user terminal 130). The network 145 may include one or more of a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc. It is noted that although the network 145 may be illustrated as part of update system 105, in embodiments, the network 145 may include a component that is separate and distinct from update system 105, and as such, the illustration of the network 145 as part of the update system 105 is for illustrative purposes and not by way of limitation.

The user-reconfigurable metal detector 110 represents an innovative approach and solution to the deficiencies of current metal detecting devices. Unlike traditional metal detectors, which are static in their feature set post-manufacture, the user-reconfigurable metal detector 110 is configured to be dynamic and adaptable to the evolving and changing requirements of its users. This configuration of the user-reconfigurable metal detector 110 of embodiments allows for a single hardware platform to serve multiple purposes, and/or to be configured for multiple classifications of metal detecting operations, which may include different performance levels and/or different metal detecting applications.

In embodiments, the user-reconfigurable metal detector 110 may include a set of hardware components that form a common hardware platform. These components may be configured to provide a wide range of functionalities and capabilities, which remain constant throughout the life of the user-reconfigurable metal detector 110. In embodiments, the hardware components of the user-reconfigurable metal detector 110 may include a processor and a memory coupled to the processor configured to provide software-based operations for controlling various components of the user-reconfigurable metal detector 110.

The hardware components of the user-reconfigurable metal detector 110 may include a transmitter configured to generate a transmit wave, a coil configured to generate a magnetic field in response to the transmit wave produced by the transmitter, and a receiver configured to capture the receive signal that is generated when the magnetic field produced by the coil interacts with a metallic object. In embodiments, the user-reconfigurable metal detector 110 may include a pre-amplifier configured to amplify the receive signal detected by the coil and captured by the receiver, a signal conditioner configured to condition the amplified receive signal from the pre-amplifier, one or more demodulators configured to demodulate the conditioned receive signal provided by the signal conditioner, an analog-to-digital (A/D) converter configured to convert the analog demodulated signal from the demodulators into a digital format to enable the subsequent digital processing of the signal by the signal processor, and a signal processor configured to analyze the digital signal provided by the A/D converter to provide metal detecting functionality. The user-reconfigurable metal detector 110 may include an input/output (I/O) module configured to operate as a communication interface between the metal detector and external devices, such as the local installer 180, a user interface configured to facilitate interaction between the user and the user-reconfigurable metal detector 110, and a reconfiguration manager configured to manage the reconfiguration of the user-reconfigurable metal detector 110.

The above and other hardware/software components of a user-reconfigurable metal detector (e.g., the user-reconfigurable metal detector 110) are described in more detail in pending and co-owned U.S. Patent Application [PLACEHOLDER reference to Garrett-00105CIP1], the entirety of which is herein incorporated by reference for all purposes.

In embodiments, the functionality of the system 100 may include functionality for constructing, creating, and/or generating a set of available features associated with the user-reconfigurable metal detector 110. The set of available features may be derived from the functionality and capabilities of the hardware components within the user-reconfigurable metal detector 110. For example, in embodiments, each feature in the set of available features associated with the user-reconfigurable metal detector 110 may be configured to leverage the functionality, combined or individual, of the various hardware components of the user-reconfigurable metal detector 110.

In embodiments, the features formed or derived from the functionality and capabilities of the hardware components within the user-reconfigurable metal detector 110 may be included in the set of available features associated with the user-reconfigurable metal detector 110. In this manner, the set of available features associated with the user-reconfigurable metal detector 110 may represent a set of features that are available to be installed, enabled, changed, or otherwise implemented in the user-reconfigurable metal detector 110. In embodiments, each feature in the set of available features associated with the user-reconfigurable metal detector 110 may represent a specific functionality provided by the arrangement or capability of one or more hardware components.

In embodiments, the user-reconfigurable metal detector 110 may be configured with a set of features that is selected from the set of available features associated with the user-reconfigurable metal detector 110. In embodiments, configuring the user-reconfigurable metal detector 110 with the set of features may include configuring the user-reconfigurable metal detector 110 with a product profile that includes (e.g., or may be defined by) the set of features.

The configuration of the user-reconfigurable metal detector 110 with the set of features, or with the product profile including the set of features, may allow the user-reconfigurable metal detector 110 to leverage the functionality associated with the features in the set of features. In embodiments, the set of features, or the product profile including the set of features, for configuring user-reconfigurable metal detector 110 may be tailored to meet the specific operational, commercial, design, and/or other types of requirements and/or preferences.

In embodiments, the system 100 may be configured with functionality to enable a user to reconfigure the user-reconfigurable metal detector 110. The reconfiguration of the user-reconfigurable metal detector 110 may include reconfiguration between different product profiles having different sets of features. The functionality of the system 100 to enable a user to reconfigure the user-reconfigurable metal detector 110 allows the user to adapt the user-reconfigurable metal detector 110 to a variety of metal detecting scenarios without the expense and inconvenience of purchasing a new metal detector hardware. For example, a user may initially purchase a metal detector with a basic product profile suitable for general metal detecting. As the customer's interest and skill level grow, the customer may choose to download, install, and/or activate a higher performance product profile (e.g., a product profile including a set of features that leverages a higher performance level of functionality from the hardware components of the user-reconfigurable metal detector 110), unlocking advanced features and enhancing the detector's capabilities, without the need or expense of a new metal detector.

In embodiments, the functionality of the system 100 to enable a user to reconfigure user-reconfigurable metal detectors (e.g., including the user-reconfigurable metal detector 110) may be provided by the functionality of update system 105. In embodiments, the update system 105 may be configured to provide functionality to enable and manage reconfiguration of user-reconfigurable metal detectors. As noted above, the update system 105 may include the backend system 150 and the local installer 180.

The local installer 180 may be configured to operate as an intermediary between the user and the user-reconfigurable metal detector 110, and between the user-reconfigurable metal detector 110 and the backend system 150, enabling reconfiguration of the user-reconfigurable metal detector 110's software to match the user's reconfiguration requests, and to enable the reconfiguration management functionality of the backend system 150. In some embodiments, the local installer 180 may be implemented as a standalone software application, a firmware module, an integrated component within the user-reconfigurable metal detector 110 itself, and or as part of the backend system 150. One function of the local installer 180 is to manage the transfer and installation of software updates, new feature sets, and product profiles that operate to modify the configuration of the metal detector.

In embodiments, the local installer 180 may be configured to provide a user interface configured to guide users through the reconfiguration process, allowing for the selection and application of desired changes to the user-reconfigurable metal detector 110's configuration. This user interface may be accessible via the user terminal 130 or directly on the user-reconfigurable metal detector 110, depending on the embodiment. Through this user interface, users may initiate reconfiguration requests, select new features to add to the current set of features of the user-reconfigurable metal detector 110, remove existing features from the set of features of the user-reconfigurable metal detector 110, or switch between different product profiles that are configured to support or enable specific classifications of metal detecting operations.

In embodiments, the local installer 180 may be configured to ensure the safety and effectiveness of the reconfiguration process, by implementing a variety of safeguards. For example, the local installer 180 may implement validation checks that verify the compatibility of new features or product profiles with the existing hardware and software of the user-reconfigurable metal detector 110, validation checks of the selected features and/or profiles to determine if they are authorized for the user-reconfigurable metal detector 110, and compatibility assessments to ensure that the reconfiguration does not introduce conflicts or impair the functionality of the metal detector, among other safeguards.

In embodiments, the local installer 180 may be configured to communicate with the backend system 150, to ensure that reconfiguration commands and associated data are accurately transmitted and executed. This may involve the local installer 180 receiving reconfiguration commands from the backend system 150, processing these commands, and then sending the appropriate signals to the user-reconfigurable metal detector 110 to implement the reconfiguration.

In embodiments, the local installer 180 may be configured to maintain a detailed history of all reconfiguration actions performed on the user-reconfigurable metal detector 110. In embodiments, this historical record may provide insight for users who wish to revert to previous configurations or troubleshoot issues that may arise during the reconfiguration process. Additionally, the local installer 180 may be configured to support updates to its own software, ensuring ongoing compatibility with future versions of the user-reconfigurable metal detector 110 and new reconfiguration requirements that may emerge.

In embodiments where the reconfiguration involves adjustments to the hardware operation of the user-reconfigurable metal detector 110, such as changes to the coil, transmitter, or receiver settings, the local installer 180 may include specialized drivers or low-level software components. These components may facilitate the direct interaction with the user-reconfigurable metal detector 110's hardware, ensuring that any reconfiguration is implemented in accordance with the hardware's specifications and within its operational limits.

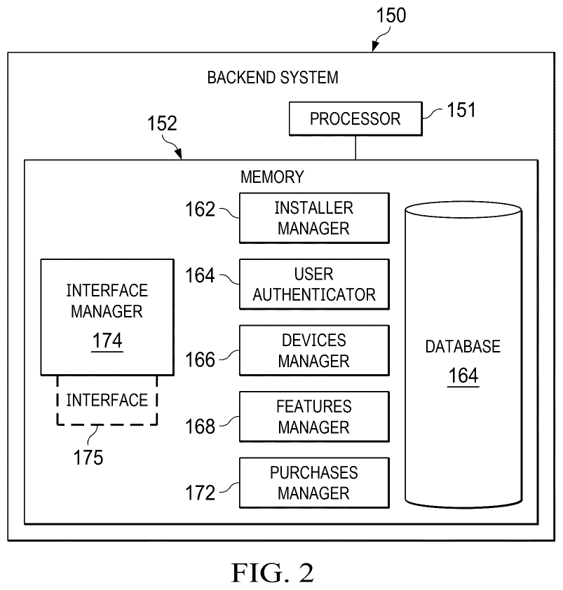

The backend system 150 may be configured to provide functionality for managing various operations to enable configuration of user-reconfigurable metal detectors (e.g., including the user-reconfigurable metal detector 110). The functionality of the backend system 150 will now be discussed with reference to FIG. 2. FIG. 2 is a block diagram of an exemplary backend system 150 configured with capabilities and functionality for managing reconfiguration of user-reconfigurable metal detectors in accordance with embodiments of the present disclosure.

It is noted that the functional blocks, and components thereof, of the backend system 150 illustrated in FIG. 2 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of the backend system 150 illustrated in FIG. 2 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of the backend system 150 illustrated in FIG. 2 described herein is provided for purposes of illustration, rather than by way of limitation and that functionalities described as being provided by different functional blocks may be combined into a single component or may be provided via computing resources disposed in a cloud-based environment accessible over a network.

As shown in FIG. 2, the backend system 150 may include processor 151, memory 152, installer manager 162, user authenticator 164, devices manager 166, features manager 168, purchases manager 172, interface manager 174, and database 164. The processor 151 may comprise a processor, a microprocessor, a controller, a microcontroller, a plurality of microprocessors, an ASIC, an ASSP, or any combination thereof, and may be configured to execute instructions to perform operations in accordance with the disclosure herein. In some embodiments, implementations of the processor 151 may comprise code segments (e.g., software, firmware, and/or hardware logic) executable in hardware, such as a processor, to perform the tasks and functions described herein. In yet other embodiments, the processor 151 may be implemented as a combination of hardware and software. The processor 151 may be communicatively coupled to the memory 152.

The memory 152 may comprise one or more semiconductor memory devices, ROM devices, RAM devices, one or more HDDs, flash memory devices, SSDs, EROM, CD-ROM, optical disks, other devices configured to store data in a persistent or non-persistent state, network memory, cloud memory, local memory, or a combination of different memory devices. The memory 152 may comprise a processor readable medium configured to store one or more instruction sets (e.g., software, firmware, etc.) which, when executed by a processor (e.g., one or more processors of the processor 151), perform tasks and functions as described herein.

The memory 152 may also be configured to facilitate storage operations. For example, the memory 152 may comprise a database 164 for storing various information related to operations of the backend system 150. In embodiments, the database 164 may store data, including user profiles, device registration details, historical records of reconfiguration actions, and a catalog of available features and product profiles associated with each metal detector. In embodiments, the database 164 may store the current configuration (e.g., current set of features and/or current product profile) for each registered metal detector, as well as any custom settings that have been applied by the users. The purchase history of features and product profiles associated with a user and/or metal detector may also be stored within database 164.

In embodiments, the database 164 may be structured to facilitate quick retrieval and update of information, ensuring that the backend system 150 can efficiently process reconfiguration requests, validate feature authorizations, and manage financial transactions related to feature purchases or refunds. Additionally, database 164 may maintain logs of user interactions and system operations. The database 164 is illustrated as integrated into the memory 152, but in some embodiments, the database 164 may be provided as a separate storage module or may be provided as a cloud-based storage module. Additionally, or alternatively, the database 164 may be a single database, or may be a distributed database implemented over a plurality of database modules.

The interface manager 174 may be configured to configured, present, and manage the user interface 175, enabling users to interact with the functionality of the backend system 150. In embodiments, the interface manager 174 may operate to configure the user interface 175 to display user account information, such as registered devices, and device details including a set of available features and product profiles associated with each registered device. In embodiments, the interface manager 174 may enable users to view their purchase history, including features, feature upgrades, and product profiles that have been purchased and are authorized for installation on a registered device.

In embodiments, the user interface 175, managed by the interface manager 174, may allow users to select features, feature updates, and/or product profiles for reconfiguring a registered metal detecting device. This selection process may trigger the interface manager 174 to send a reconfiguration signal to the local installer 180, which may perform the reconfiguration based on the user's selections. Additionally, the interface manager 174 may facilitate the purchase of features, feature updates, and/or product profiles when such transactions are necessitated by the user's selections.

In some embodiments, the interface manager 174 may provide functionality for users to customize product profiles by selecting features and configuring the features to be included in the customized product profile. This customization process may include presenting users with options to add, remove, and/or modify features within a product profile, as well as adjusting the configuration settings for each feature to match the user's specific requirements and/or preferences.

The user authenticator 164 may be configured to authenticate a user attempting to access the functionality of the backend system 150, such as via the user interface 175 provided by the interface manager 174. In embodiments, the user authenticator 164 may operate to verify the identity of the user by checking the provided credentials against a database of authorized users, which may be stored within the database 164. This process may include validating usernames, passwords, and potentially additional security measures such as two-factor authentication or biometric data to ensure that access to the system is granted to legitimate users.

In some embodiments, the user authenticator 164 may also be configured to manage user sessions, ensuring that users remain authenticated while they interact with the backend system 150. This may involve the generation of session tokens that are used to maintain the state of the user's session across multiple interactions with the system. The user authenticator 164 may also be responsible for logging user access, tracking login attempts, and providing alerts for any unauthorized access attempts. In some embodiments, the user authenticator 164 may be configured to support user account management functions, such as password resets, account recovery, and the updating of user profile information.

The installer manager 162 may be configured to interface and communicate with the local installer 180 to manage the reconfiguration operations for the user-reconfigurable metal detector 110. In some embodiments, the installer manager 162 may operate to process reconfiguration requests that originate from the local installer 180. These requests may include inquiries about the registration status of metal detecting devices, as well as requests for information on devices that are already registered within the system. For example, when the local installer 180 operates to determine whether a particular metal detecting device is registered, the installer manager 162 may operate to query the database 164 for the metal detecting device's registration details. If the metal detecting device is found to be registered, the installer manager 162 may provide the local installer 180 with information on the metal detecting device, which may include the set of available features associated with the device, features that have been purchased for that device, firmware updates available for the device, product profiles available for that device, any custom settings that have been applied by the user, etc.

In embodiments, the installer manager 162 may be configured to coordinate the transfer of data between the backend system 150 and the local installer 180 for reconfiguration operations. This functionality may include sending commands to the local installer 180 to initiate the installation of software updates, new feature sets, and product profiles that modify the configuration of the metal detecting devices. Additionally, the installer manager 162 may receive feedback from the local installer 180 regarding the status of reconfiguration actions, ensuring that the backend system 150 maintains an accurate and up-to-date record of all modifications made to each registered metal detecting device.

In some embodiments, the installer manager 162 may be implemented as a software module that operates upon the processor 151 and interacts with the memory 152 to access and manage the data stored within the database 164. In embodiments, the installer manager 162 may employ various communication protocols to ensure secure and efficient data exchange with the local installer 180 and may employ encryption techniques to protect sensitive information during transmission.

The devices manager 166 may be configured to manage device-related functionality of the backend system 150. For example, in embodiments, the devices manager 166 may be configured to manage various aspects of the registered metal detecting devices within the backend system 150. In embodiments, the devices manager 166 may operate to maintain a record of all registered metal detecting devices, including their identification information such as serial numbers, model numbers, and user ownership details. This information may be used to track the registration status of each metal detecting device and to ensure that each metal detecting device is correctly associated with the appropriate user account.

In embodiments, the devices manager 166 may be configured for managing the configuration of registered metal detecting devices. This functionality may include overseeing the set of features that are available for each metal detecting device, as well as the product profiles that can be installed on the metal detecting devices. In some embodiments, the devices manager 166 may cooperatively operate with the features manager 168 to update the list of available features and product profiles as new options become available, ensuring that users have access to the latest enhancements for their metal detectors.

In embodiments, the devices manager 166 may be configured to manage and track the purchase history of features, feature upgrades, and/or product profiles for each registered metal detecting device. This functionality may include enabling and recording transactions within the database 164, providing users with a history of their purchases, and enabling the backend system 150 to process refunds or credits as applicable. The devices manager 166 may facilitate the association of newly purchased features or product profiles with the appropriate metal detecting devices, ensuring that users can include these new capabilities into their metal detecting devices.

In some embodiments, the devices manager 166 may be configured to manage identification information about the registered devices. This may include updating device details, managing custom settings applied by users, and ensuring that the backend system 150 has accurate and up-to-date information for each metal detecting device.

The purchases manager 172 may be configured to facilitate the financial transactions associated with the customization of the metal detector's features and/or product profiles. For example, in embodiments, the purchases manager 172 may operate as a transactional gateway that enables users to securely purchase new features, feature upgrades, and/or product profiles that are available for their metal detecting devices. The purchases manager 172 may be integrated with payment processing systems to handle transactions, ensuring that payments are processed efficiently and securely.

In some embodiments, the purchases manager 172 may provide refund functionality for features that are removed or downgraded, and/or for product profiles that are no longer in use. This refund functionality may be particularly beneficial in scenarios where users are allowed to trial features or product profiles before making a final decision. If a user decides that a particular feature and/or product profile does not meet their expectations or requirements, the feature and/or product profile may be removed from the metal detecting device and the purchases manager 172 may process a refund, crediting the user's account with the appropriate amount based on the value of the feature and/or product profile.

In embodiments, the purchases manager 172 may be configured to maintain a record of all purchase transactions within the database 164. This record may include details such as the date of purchase, the features or product profiles purchased, the amount paid, and any refunds issued. By tracking this information, the purchases manager 172 may provide users with a comprehensive view of their purchase history.

In embodiments, the purchases manager 172 may be configured to communicate with the features manager 168 and the devices manager 166 to ensure that purchased features and product profiles are correctly associated with the user's registered devices. This coordination may ensure that users have access to the features and/or product profiles they have purchased and that these functionalities are properly enabled or installed on their metal detecting devices.

The features manager 168 may be configured to manage and configure the features and product profiles associated and/or available for the metal detecting devices. In embodiments, the features manager 168 may be configured to generate the set of available features and product profiles that can be installed or activated on the metal detectors.

For example, the features manager may include functionality for creating, constructing, and/or generating a set of available features associated with each of a plurality of user-reconfigurable metal detectors. For example, the features manager may include functionality for creating, constructing, and/or generating a set of available features associated with the user-reconfigurable metal detector 110. The set of available features associated with a user-reconfigurable metal detector (e.g., the user-reconfigurable metal detector 110) may be derived from the functionality and capabilities of the hardware components within the user-reconfigurable metal detector.

For example, the functionality of the transmitter of the user-reconfigurable metal detector 110, which may be configured to generate the transmit wave, may be managed by the functionality of the processor. In this example, the functionality of the transmitter and the processor with respect to the generation of the transmit wave may be combined to form a feature that allows users to control characteristics of the transmit wave. In particular, a feature related to the frequency of the transmit wave may be formed. This feature, which may be referred to as the “transmit wave frequency” feature, may enable configuration of the frequency of the transmit wave, and may be leveraged by the user-reconfigurable metal detector 110 to tune the user-reconfigurable metal detector 110 for different detection scenarios, such as adjusting the frequency to improve detection of small objects or to penetrate deeper into the ground.

In the same manner, other features associated with the user-reconfigurable metal detector 110 may be formed leveraging the functionality, combined or individual, of the various hardware components of the user-reconfigurable metal detector 110. Indeed, other particular features that may be included in the set of available features of the user-reconfigurable metal detector 110 will be discussed in more detail below.

In embodiments, features manager 168 may operate to include the features formed in the set of available features associated with the user-reconfigurable metal detector 110. In this manner, the set of available features associated with the user-reconfigurable metal detector 110 may represent a set of features that are available to be installed, enabled, or otherwise implemented in the user-reconfigurable metal detector 110. In embodiments, each feature in the set of available features associated with the user-reconfigurable metal detector 110 may represent a specific functionality provided by the arrangement or capability of one or more hardware components.

In embodiments, one or more features of the set of available features associated with the user-reconfigurable metal detector 110 may be configurable with varying levels of performance. This is in contrast with one or more one or more features of the set of available features associated with the user-reconfigurable metal detector 110 that may be configurable as either enabled or disabled, with nor varying levels of performance. The varying levels of performance may provide a spectrum of operational capabilities associated with an available feature that can be tailored to specific metal detecting requirements and/or operations. For example, an available feature that defines the number of frequencies that can be used in a multi-frequency configuration can have different levels, each offering a distinct number of frequencies to enhance detection capabilities. For example, at a first level, this available feature may include the use of two frequencies, at a second level this available feature may include an increased number of frequencies to 4four and at a third level this available feature may include an increased number of frequencies to seven.

In embodiments, the set of available features associated with the user-reconfigurable metal detector 110 may include a “detection performance comparison” feature, which may allow users to evaluate the performance of the user-reconfigurable metal detector 110 against a predefined baseline. This baseline may be established based on the performance characteristics of other metal detector models or a set of industry-standard metrics. This feature may enable users to conduct comparative analyses of detection capabilities, such as depth penetration, sensitivity, and discrimination accuracy. By utilizing this feature, users can gain insights into how their metal detector's hardware, such as the transmitter 120, coil 122, and receiver 124, among others, performs in various environments and against different types of metal objects.

In embodiments, the set of available features associated with the user-reconfigurable metal detector 110 may include a “Cumulative Increased Detection Depth” feature, which may operate to enhance the metal user-reconfigurable metal detector 110's ability to detect objects at greater depths. This feature may leverage advanced signal processing techniques that operate to differentiate between various types of metals and ground minerals, which may facilitate the optimization of the detection capabilities for deeper targets. By managing the metal detector's sensitivity and gain, users can adjust the depth at which the detector is able to identify metal objects. In additional or alternative embodiments, the implementation of different algorithms may affect the functionality of this feature, such as by employing frequency modulation to penetrate deeper into the ground or by utilizing machine learning to recognize patterns indicative of deeper buried objects.

In embodiments, the set of available features associated with the user-reconfigurable metal detector 110 may include an “Iron Volume” feature, which may be related to the functionality of the metal user-reconfigurable metal detector 110 to control the audio response to iron targets. This feature may operate to adjust the volume of the audio signal produced when the metal user-reconfigurable metal detector 110 identifies an iron target. In areas with high concentrations of iron trash or ground iron mineralization, the Iron Volume feature can be particularly useful, as it may help users distinguish between actual targets and unwanted iron objects. Instead of completely discriminating out iron and potentially missing valuable items that might be associated with it, the Iron Volume feature allows the user to lower the volume of the iron signals through the user interface 140. This way, iron targets are still detected and reported, but they produce a quieter audio signal, making it easier to focus on more desirable targets like coins, relics, or precious metals. This feature allows the user to avoid the annoyance and distraction of loud iron signals, but still remain aware of their presence.

In embodiments, the set of available features associated with the user-reconfigurable metal detector 110 may include a “Volume Control” feature, which may be related to the functionality of the metal user-reconfigurable metal detector 110 to adjust the volume of the audio signals produced by the metal user-reconfigurable metal detector 110. In embodiments, this feature may operate to increase or decrease the sound output from the metal user-reconfigurable metal detector 110's speaker or headphones, providing users with the ability to tailor the auditory feedback to their environment or personal hearing preferences. For instance, in noisy surroundings, the user may increase the volume to ensure that the audio cues are clearly heard over the ambient noise. Conversely, in quiet or sensitive areas, the user may decrease the volume to minimize disturbance to others. The Volume Control feature can be advantageous when using headphones, as it may allow users to manage the sound level directly at their ears, which can be beneficial for prolonged metal detecting sessions and for maintaining situational awareness.

In embodiments, the set of available features associated with the user-reconfigurable metal detector 110 may include a “Screen Backlight” feature, which may be related to the functionality of the metal user-reconfigurable metal detector 110 to illuminate the display screen. This feature may enable users to activate a backlight for the display screen, allowing the information presented on the screen to be easily read in low-light conditions or during night-time detecting sessions. The Screen Backlight feature may be useful for users who engage in metal detecting activities during the early morning hours, late evenings, or in shaded areas where visibility of the display is compromised. By adjusting the brightness and duration of the backlight through the user interface 140, users may customize the visibility of the display to their specific environmental conditions.

In embodiments, the set of available features associated with the user-reconfigurable metal detector 110 may include a “Number of Tones” feature, which may be related to the functionality of the user-reconfigurable metal detector 110 to produce distinct audio tones to indicate various types of metal targets. This feature may enable users to differentiate between different types of metals and to assess the potential value of the detected objects. In embodiments, the Number of Tones feature may be configurable with different levels. For example, a first level of this feature may include three tones, which may be configured to signify different categories. A higher second level may include five tones, providing a more granular distinction between metal types. An even higher third level may include five tones, but with the added functionality to adjust the break points between the different tones, allowing users to customize the audio feedback based on their preferences or the specific metal detecting environment.

In embodiments, the set of available features associated with the user-reconfigurable metal detector 110 may include an “Iron Audio” feature, which may be related to the functionality of the user-reconfigurable metal detector 110 to generate distinct audio signals for iron targets that are separate from those for other types of metals. This feature may operate to provide a specialized audio tone or range of tones that are uniquely associated with iron, enabling users to audibly discern iron targets from other valuable metals. The Iron Audio feature may be particularly advantageous in environments where iron trash is prevalent, allowing users to quickly identify and disregard unwanted iron signals without the need to visually inspect the target. In embodiments, the Iron Audio feature may include functionality to adjust the tonal quality or pitch of the iron audio signal to suit the user's preferences or to contrast more distinctly against the audio signals for non-iron targets.

In embodiments, the set of available features associated with the user-reconfigurable metal detector 110 may include a “Multi-Frequency” feature, which may be related to the functionality of the user-reconfigurable metal detector 110 to operate at different frequencies either simultaneously or by switching between the frequencies. This feature may operate to allow users to configure the number of frequencies that are to be used by the metal detector and/or the frequencies themselves. In embodiments, the Multi-Frequency feature may be configurable with different levels. For example, at a first level, the Multi-Frequency feature may include the use of two frequencies or two frequency modes, such as a fixed frequency mode and a multiple simultaneous frequencies mode. This level can be particularly useful for general metal detecting activities. A higher second level of the Multi-Frequency feature may expand the number of frequencies to four, which may include a multiple simultaneous frequencies mode, a multi-salt mode for beach and salt-water applications, and specific frequencies such as 5 KHz and 13 KHz. This second level offers a more refined detection experience, enabling users to better discriminate between different types of metals and adapt to varying ground conditions, including those with high mineral content. An even higher third level of the Multi-Frequency feature may include the use of seven frequencies, which may include a multiple simultaneous frequencies mode, a multi-salt mode for beach and salt-water applications, and a range of specific frequencies such as 5 KHz, 9 KHz, 13 KHz, 18 KHz, and 25 KHz. This third level may provide an even greater degree of precision and control, allowing for intricate adjustments to the detector's response to different metals.

In embodiments, the set of available features associated with the user-reconfigurable metal detector 110 may include a “Number of Discrimination Modes” feature, which may be related to the functionality of the user-reconfigurable metal detector 110 to filter out unwanted metal types and focus on specific targets. In embodiments, the Number of Discrimination Modes feature may be configurable with different levels. For example, at a first level, this feature may include four discrimination modes: a no discrimination mode for detecting all metal types without filtering, a standard mode for basic filtering to ignore common trash items like nails, bottle caps, and other small iron objects, a US coin mode for detecting US coins and ignoring objects except those determined to be US coins, and a custom mode for enabling the user to manually set preferences to accept or reject specific types of metals detected, such as based on their conductivity. A higher second level may include five discrimination modes, adding a beach mode for metal detecting in sandy and wet environments, such as on beaches, which adjusts the metal detector's settings to handle the mineralization and salt content commonly found in these areas. An even higher third level may include seven discrimination modes, incorporating the no discrimination mode, the US coin mode, the custom mode, the beach mode, a thin coins mode for detecting small, thin coins, and a fast mode for operating in areas with a high density of targets, which increases the metal detector's recovery speed and allows it to quickly reset between signals and accurately identify targets that are close to each other.

In embodiments, the set of available features associated with the user-reconfigurable metal detector 110 may include a “Wireless Mode” feature, which may be related to the functionality of the user-reconfigurable metal detector 110 to enable or disable wireless communications. This feature may allow users to enable the user-reconfigurable metal detector 110 to establish wireless connections with the local installer and/or the backend system for reconfiguration operations of the metal detector. By enabling the Wireless Mode, users can receive updates, download new features, new product profiles, and/or otherwise reconfigure the user-reconfigurable metal detector 110 without the use of physical cables or connections. In some embodiments, the Wireless Mode feature may be used to enable the user-reconfigurable metal detector 110 to wirelessly transmit data related to metal detection operations, such as the types of objects detected, their location, and other relevant metadata, to other components, such as the user terminal 130, the local installer 180, and/or the backend system 150. In embodiments, the received data may be stored and analyzed to track detection patterns, improve search strategies, or share findings with a community of users.

In embodiments, the set of available features associated with the user-reconfigurable metal detector 110 may include a “Phase Roll Target ID” feature, which may be related to the functionality of the user-reconfigurable metal detector 110 to identify and differentiate between metal targets based on their phase response. By analyzing the phase angle changes in the signal returned by a target, this feature provides more precise target identification. Different metals and target shapes affect the phase angle uniquely, allowing the detector to classify targets more accurately. In embodiments, this data may be translated into readable information on the detector's display, helping users distinguish valuable items from unwanted metal objects. The Phase Roll Target ID feature may be particularly useful in areas with a high density of metal objects, enabling users to quickly and effectively identify and prioritize targets during metal detecting activities.

In embodiments, the set of available features associated with the user-reconfigurable metal detector 110 may include a “Multi-Dimensional Multi-Frequency” feature, which may be related to the functionality of the user-reconfigurable metal detector 110 to enable simultaneous multi-frequency operation. By emitting and analyzing multiple frequencies at once, this feature may provide balanced sensitivity to a wide range of target sizes and types. In embodiments, the functionality of the Multi-Dimensional Multi-Frequency feature may be used to examine various signal dimensions, such as phase shift, amplitude, and time delay, to accurately differentiate between metals and ground minerals. This results in clearer, more precise target identification, reducing false positives and improving performance in challenging conditions like mineralized soils or cluttered areas. In embodiments, the Multi-Dimensional Multi-Frequency feature may leverage the combined capabilities of the transmitter 120, coil 122, and receiver 124, along with advanced signal processing algorithms within the signal processor 134, to provide analysis of the detected signals.

In embodiments, the set of available features associated with the user-reconfigurable metal detector 110 may include a “Target ID Scale/Graphs” feature, which may be related to the functionality of the user-reconfigurable metal detector 110 to visually represent a detected target's characteristics on the metal detector's display. The functionality of the Target ID Scale/Graphs feature may be used to configure the display to include numerical scales and graphical indicators that provide detailed information about the target's conductivity and probable identity. The target ID scale may be used to assign numerical values to different types of metals, facilitating quick and accurate identification. Graphical representations, such as histograms or bar graphs, visually display the signal strength and consistency. In embodiments, the Target ID Scale/Graphs feature may be configurable with different levels. For example, at a first level, this feature may include a single graph configured to display target ID values from 0-99, providing a straightforward and effective means of target identification. At a higher second level, a two-tiered display may be presented, with each tier providing additional information related to the target ID. At an even higher third level, a three-tiered display may be presented, each tier offering enhanced information related to the target ID.

In embodiments, the set of available features associated with the user-reconfigurable metal detector 110 may include a “Frequency Shift” feature, which may be related to the functionality of the user-reconfigurable metal detector 110 to adjust the operating frequency to mitigate electromagnetic interference from other detectors or electronic devices. This feature is particularly advantageous in crowded areas where multiple detectors are in use, as overlapping frequencies can lead to false signals and diminished detection accuracy. Users can activate the Frequency Shift feature through the user interface 140, selecting an alternative operating frequency that minimizes interference while maintaining the user-reconfigurable metal detector 110's sensitivity and performance. In embodiments, the functionality of the Frequency Shift feature may include functionality to enable the user-reconfigurable metal detector 110 to automatically suggest and switch to the least congested frequency based on real-time analysis of the electromagnetic environment, or to allow the user to manually select the desired frequency.

In embodiments, the set of available features associated with the user-reconfigurable metal detector 110 may include a “Pinpoint Mode” feature, which may be related to the functionality of the user-reconfigurable metal detector 110 to enable users to precisely locate the exact position of a detected target. In embodiments, once the general vicinity of a target is identified through the metal detector's standard search modes, engaging the Pinpoint Mode may operate to narrow down the search to pinpoint the target's exact location. In embodiments, the pinpoint mode may generate a constant audio tone that increases in intensity as the coil of the metal detector approaches the center of the target. The closer the coil gets to the target, the stronger the audio signal becomes, providing continuous and intuitive feedback to the user. This feature may be particularly useful for users who wish to minimize the digging area and recover targets more efficiently, such as in archeological metal detecting applications, as it may reduce the likelihood of damaging the target during excavation and saves time by avoiding unnecessary digging.

In embodiments, the set of available features associated with the user-reconfigurable metal detector 110 may include a “Ground Balance” feature, which may be related to the functionality of the user-reconfigurable metal detector 110 to adjust for varying levels of mineralization in the soil. Different soils can contain varying amounts of naturally occurring minerals, which can produce false signals that interfere with the detection of metal objects. The Ground Balance feature may include functionality to neutralize these effects by calibrating the detector to ignore the background mineral signals, focusing on detecting metal objects. This feature may operate by allowing users to manually adjust the ground balance settings or by implementing automatic ground balancing algorithms that assess and compensate for the mineralization in real-time.

In embodiments, the set of available features associated with the user-reconfigurable metal detector 110 may include a “Variable Recovery/Reactivity” feature, which may be related to the functionality of the user-reconfigurable metal detector 110 to quickly reset and be ready to detect new targets after identifying a previous one. This feature may be particularly useful in areas with high target density, as it may allow the user-reconfigurable metal detector 110 to effectively distinguish between closely spaced objects. In embodiments, the Variable Recovery/Reactivity feature may be configurable with different levels. For example, at a first level, the Variable Recovery/Reactivity feature may include two modes: a standard mode for typical detecting conditions and a fast mode for areas with high target density, enabling quicker recovery times between signals. At a higher second level, three modes of varying and increasing speeds (e.g., standard, fast, faster) may be used, providing users with enhanced control over the detection speed and allowing for more precise separation of targets in close proximity.

In embodiments, the set of available features associated with the user-reconfigurable metal detector 110 may include software-affected physical features, where software commands may enable or disable hardware components, resulting in changes to the metal detector's physical functionality. For example, a “Keypad Lock” feature may be implemented through software to disable the physical keypad of the metal detector. When activated, this feature may prevent the keys from responding to presses, which may be useful in preventing accidental input, unauthorized use, or other issues. This software-driven control may extend to other components as well, such as disabling the coil or adjusting the sensitivity of the receiver, which may result in altering the physical detection capabilities of the device.

It is noted that the specific features described herein as part of the set of available features associated with the user-reconfigurable metal detector 110 are provided for illustrative purposes and are not intended to be exhaustive or to limit the disclosure in any manner. In some embodiments, the set of available features associated with the user-reconfigurable metal detector 110 may include additional features not explicitly discussed, which may offer further enhancements or specialized functionalities tailored to the diverse requirements of metal detecting operations. These additional features may include advancements in detection technology, user interface improvements, and/or novel applications that extend the utility of the metal detector beyond the examples provided. The scope of the available features is intended to be broad and flexible, allowing for the incorporation of future innovations and user-driven customizations that may advance metal detecting capabilities.

In embodiments, the functionality of the features manager 168 to generate the product profiles that can be installed or activated on the metal detecting devices (e.g., including the user-reconfigurable metal detector 110) may include functionality to include a set of features to each product profile selected from the set of available features. As noted above, in embodiments, a product profile with which the user-reconfigurable metal detector 110 may be configured may represent a tailored configuration that represents a combination of selected features from the set of available features, configured to meet specific operational, commercial, design, and/or other types of requirements and/or preferences. For example, a product profile may be generated or constructed by selecting a set of features from the set of available features, such as described herein. Once this selection of features is made, the selected set of features is included in the product profile.

In embodiments, the configuration of the product profile may define a configuration for each of the features in the set of features included in the product profile. For example, in embodiments, for each feature selected to be part of a product profile, there may be a specific configuration that determines how that feature will operate within the context of the metal detector's operations. For example, a feature such as the Number of Tones feature may be included in a product profile and may be configured at a particular level for that profile. For example, the Number of Tones feature may be included in a product profile and may be configured with three tones. However, in another product profile, the Number of Tones feature may also be included but may be set at a higher level with more tones, such as the second or third level.

In embodiments, features within the set of available features may not be configurable with multiple levels of performance but instead may be configured in a binary manner as either enabled or disabled within a product profile. For example, product profiles may include the Iron Volume feature. In one product profile, the Iron Volume feature may be configured as disabled, meaning that the functionality associated with this feature is not active, and the metal detector configured with this product profile will not provide differentiated audio feedback for iron targets. Conversely, another product profile may also include the Iron Volume feature, but in this case, the feature may be configured as enabled. When the feature is enabled, the metal detector configured with this product profile will offer the functionality of the Iron Volume feature, allowing the user to adjust the volume of the audio signals for iron targets. This may enable users to lower the volume for less desirable targets, such as iron, while maintaining higher volume levels for more valuable targets.

In some embodiments, features may be available but may not be immediately visible within a product profile due to the current configuration settings or operational mode of the metal detector. For example, a feature such as the Frequency Shift feature may be available but not active when the metal detector is operating in a single frequency mode. Users may activate or reveal such features by adjusting the product profile settings or switching to a different operational mode that supports the feature.

In embodiments, once a product profile has been established or constructed, the user-reconfigurable metal detector 110 may be configured to leverage the functionality of the included set of features, enabling the user-reconfigurable metal detector 110 to perform according to the functionality provided by the product profile. Each feature within the product profile may contribute to the overall performance and/or functionality of the user-reconfigurable metal detector 110.

For example, if the product profile includes the Multi-Frequency feature, a user-reconfigurable metal detector configured with the product profile may be configured to utilize multiple frequencies during operations. This configuration may enable the user-reconfigurable metal detector to effectively search for a variety of metal types across different soil conditions, as the multiple frequencies can penetrate the ground at varying depths and respond to different metal conductivities. In this case, the user of the user-reconfigurable metal detector may benefit from an enhanced detection experience, as the Multi-Frequency feature allows for the identification of a broader range of targets than would be possible with a single frequency.

Similarly, if the Ground Balance feature is part of the product profile, the user-reconfigurable metal detector 110 configured with the product profile may be configured to automatically or manually adjust its settings to compensate for the mineralization present in the soil. As noted above, this feature operates to ensure that the user-reconfigurable metal detector remains sensitive to metal targets while minimizing the effects of ground mineralization.

In embodiments, a plurality of product profiles may be provided for configuring a user-reconfigurable metal detector. Each product profile of the plurality of product profiles may be configured designed to cater to the diverse preferences and requirements of users. In embodiments, each product profile of the plurality of product profiles may include a different sets of features including features selected from the set of available features for the metal detector. In embodiments, the difference between the product profiles of the plurality of product profiles may include a difference in the number of features. For example, a first product profile may have fewer features compared to a second product profile, reflecting a more basic or entry-level configuration. The first product profile may be suitable for beginners or users who prefer simplicity in their metal detecting activities. Conversely, the second product profile, with a greater number of features, may offer advanced capabilities for experienced users or those seeking a more sophisticated metal detecting experience.

In embodiments, the difference between the product profiles of the plurality of product profiles may include a difference in the configuration of individual features. For example, one or more features may be included in a first and second profiles. However, in the second product profile, the one or more features may be configured with a higher level than the level at which the one or more features are configured in the first profile. In this case, the second product profile may be considered to be higher or an upgrade from the first profile, as it provides a higher level of functionality and adaptability to various metal detecting conditions. For example, both the first and second product profiles may include the Multi-Frequency feature. However, in the first product profile, this feature may be configured to operate with two frequencies, while the second product profile may configure the Multi-Frequency feature with four frequencies, offering enhanced detection performance. In this example, the second product profile may be considered an upgrade from the first product profile.

In embodiments, the different product profiles of the plurality of product profiles available for configuring the reconfigurable metal detector 110 may be configured to facilitate different classifications of metal detecting operations of the metal detector. In some embodiments, the classifications of metal detecting operations may include the levels of performance that may be achievable based on the functionality of the configured product profile. For example, a first product profile may be configured to facilitate a basic classification of metal detecting operations, suitable for beginner users or those who engage in metal detecting as a leisure activity. In embodiments, the first product profile may include a limited set of features, such as basic discrimination modes and a fixed frequency operation, which may provide a straightforward and user-friendly metal detecting experience.

On the other hand, a second product profile may be configured to support a more advanced classification of metal detecting operations, offering a higher level of performance than the first product profile. This could be due to the inclusion of features in the second product profile that are configured at a higher level, such as enhanced multi-frequency feature, higher ground balancing algorithms, and a higher number of discrimination modes, among other features. In embodiments, a user-reconfigurable metal detector configured with the second product profile may be capable of more complex detection tasks, such as identifying a wider range of metal types, operating effectively in varied terrains, and providing more detailed information about detected targets. Consequently, users who are more experienced or who have specific metal detecting goals, such as professional relic hunters or gold prospectors, may find this advanced product profile more aligned with their requirements.

In some embodiments, a product profile configured to enable or support a higher classification of metal detecting operations may include features that are configured at a higher level of performance than a product profile configured to enable or support a lower classification of metal detecting operations. For example, while both a first and second product profiles may include a Target ID Scale/Graphs feature, the first product profile may configure this feature with a basic numerical scale for target identification, whereas the second product profile may configure this feature with a more detailed graphical representation.

In embodiments, configuring the different product profiles of the plurality of product profiles available for configuring the user-reconfigurable metal detector 110 to facilitate different classifications of metal detecting operations of the metal detector may allow for dynamic reconfiguration of product profiles to match the evolving skills and interests of the user. As users gain experience and refine their metal detecting techniques, the users may opt to transition from a product profile that supports basic operations to one that enables more advanced operations. This progression is facilitated by the reconfigurable nature of the user-reconfigurable metal detector 110, which in this case may be updated to reflect the user's current level of expertise without the inconvenience of purchasing a new device.

In embodiments, the different product profiles with which the user-reconfigurable metal detector 110 may be configured may include a product profile configured for entry level performance. In embodiments, the entry level product profile may include features tailored to provide functionality with an entry level of performance. For example, the entry level product profile may include features such as Volume Control, Screen Backlight, Iron Audio, Multi-Dimensional Multi-Frequency, Frequency Shift, Pinpoint Mode, and Ground Balance, among others. In this example, the entry level product profile may include the Number of Tones feature configured at the first level with three tones, the Multi-Frequency feature configured at the first level with two frequencies, the Number of Discrimination Modes configured at the first level with four discrimination modes, and the Target ID Scale/Graphs feature configured at the first level with one 0-99 ID graph. In this example, the entry level product profile may not include the Cumulative Increased Detection Depth feature, the Iron Volume feature, the Wireless Mode feature, the Phase Roll Target ID feature, or the Variable Recovery/Reactivity feature.

In embodiments, the different product profiles with which the user-reconfigurable metal detector 110 may be configured may include a product profile configured for medium level performance. In embodiments, the medium level product profile may include features tailored to provide functionality with a level of performance higher than the entry level of performance. For example, the medium level product profile may include features such as Cumulative Increased Detection/Depth, Iron Volume, Volume Control, Screen Backlight, Iron Audio, Wireless Mode, Phase Roll Target ID, Multi-Dimensional Multi-Frequency, Frequency Shift, Pinpoint Mode, and Ground Balance, among others. In this example, the medium level product profile may include the Number of Tones feature configured at the second level with five tones, the Multi-Frequency feature configured at the second level with four frequencies, the Number of Discrimination Modes configured at the second level with five discrimination modes, the Target ID Scale/Graphs feature configured at the second level with two-tiered target scales, and the Variable Recovery/Reactivity feature configured at the first level with 2 settings (e.g., standard and fast).

In embodiments, the different product profiles with which the user-reconfigurable metal detector 110 may be configured may include a product profile configured for advanced level performance. In embodiments, the advanced level product profile may include features tailored to provide functionality with a level of performance higher than the medium level of performance. For example, the advanced level product profile may include features such as Cumulative Increased Detection/Depth, Iron Volume, Volume Control, Screen Backlight, Iron Audio, Wireless Mode, Phase Roll Target ID, Multi-Dimensional Multi-Frequency, Frequency Shift, Pinpoint Mode, and Ground Balance, among others. In this example, the advanced level product profile may include the Number of Tones feature configured at the third level with five tones with adjustable breaks, the Multi-Frequency feature configured at the third level with seven frequencies, the Number of Discrimination Modes configured at the third level with seven discrimination modes, the Target ID Scale/Graphs feature configured at the third level with three-tiered target scales, and the Variable Recovery/Reactivity feature configured at the second level with 2 settings (e.g., standard and fast).

In embodiments, the classifications of metal detecting operations that the different product profiles of the plurality of product profiles available for configuring the reconfigurable metal detector 110 may be configured to facilitate or support may include metal detecting applications for which the functionality of the product profile (e.g., the functionality of the set of features included in the product profile) may be tailored. For example, in embodiments, different product profiles may be configured or tailored to facilitate or enable different metal detecting applications. For example, a first product profile may be configured to support a classification of operations that includes beach treasure hunting, while a second product profile may be tailored for relic hunting in historical sites. These metal detecting application-based classifications may be indicative of the metal detecting application for which the metal detector is optimized when configured with the respective product profile.

For example, a first product profile may be configured to facilitate or support metal detecting applications that include beach treasure hunting, while a second product profile may be configured to facilitate or support metal detecting applications that include relic hunting. In this example, the set of features included in the first product profile may be tailored for beach treasure hunting and may differ from the set of features included in the second product profile tailored for relic hunting, as each set of features is selected and configured to enhance the performance of the metal detector for the intended metal detecting application. For beach treasure hunting, for example, the first product profile might prioritize features such as the Multi-Salt mode feature to handle the conductive properties of wet sand and saltwater, and a Waterproof Coil feature for submersion in shallow waters. Conversely, the relic hunting product profile may emphasize features such as Iron Audio to discriminate against ferrous objects and Deep Signal Processing to detect relics buried at greater depths.

In embodiments, a user-reconfigurable metal detector configured with a product profile configured to facilitate or support a particular metal detecting application may include features that leverage the functionality of the metal detector to perform that metal detecting application effectively. For example, a product profile configured to facilitate or support gold prospecting applications may include a High-Frequency Operation feature to detect small gold nuggets and a Ground Balance feature with fine-tuning capabilities to compensate for the high mineralization often found in gold-bearing soils.

In a particular example, the reconfigurable metal detector 110 may be configured to render or display icons and other graphical elements on the metal detector display based on the particular metal detecting application that the current product profile of the reconfigurable metal detector 110 is configured to support. For example, for beach treasure hunting, the current product profile may include features to configure the display of the reconfigurable metal detector 110 to display icons such as waves, sand, and shells to represent the environment, while for relic hunting, the current product profile may include features to configure the display of the reconfigurable metal detector 110 to display icons that may include historical artifacts, coins, and tools. In embodiments, the layout and configuration of the display may also be adapted for different metal detecting applications. For example, a first product profile configured to support a first metal detecting application may include features to configure a user interface displayed on the display of the reconfigurable metal detector 110 using a layout that presents the information and controls in a manner that is intuitive and relevant to the first metal detecting application. Conversely, a second product profile configured to support a second metal detecting application may include features to configure the user interface displayed on the display of the reconfigurable metal detector 110 using a layout that presents the information and controls in a manner that is intuitive and relevant to the second metal detecting application. For example, the display layout for a product profile configured for law enforcement applications may prioritize quick access to features such as Weapon Detection modes and Evidence Logging, whereas a layout for coin shooting may focus on Target ID and Pinpoint Mode for efficient recovery of coins.

In embodiments, the different product profiles with which the user-reconfigurable metal detector 110 may be configured may include a law enforcement product profile specifically configured for security and law enforcement applications. This specialized product profile may incorporate features that are tailored to facilitate law enforcement metal detecting operations, such as the detection of weapons, contraband, or evidence recovery. Features within this profile may include a Weapon Detection mode that is optimized for identifying firearms and knives, an Evidence Preservation feature that logs the location and time of detected items, a High-Sensitivity setting for detecting small metallic components that may be part of a criminal investigation. In some embodiments, the law enforcement product profile may include a streamlined set of features that foregoes a number of advanced features of the set of available features associated with the user-reconfigurable metal detector 110 in favor of a more simplified product profile. In some embodiments, the law enforcement product profile may also configure the layout of the display for law enforcement operations. In some embodiments, the law enforcement product profile may include features related to data encryption and secure wireless communication to ensure the integrity and confidentiality of sensitive information.

In embodiments, the different product profiles with which the user-reconfigurable metal detector 110 may be configured may include a relic hunting product profile, which may be configured to support operations for searching for relics and archaeological objects. In embodiments, this product profile may include features such as Ground Disturbance Detection to identify areas that have been previously excavated, Artifact Material Identification to distinguish between different types of metals commonly found in historical artifacts, and Deep Signal Processing for locating objects buried at greater depths. The relic hunting product profile may enable archaeologists and relic hunters to conduct their searches with greater precision and efficiency.

In embodiments, the different product profiles with which the user-reconfigurable metal detector 110 may be configured may include a treasure hunting product profile that may be configured to support operations aimed at detecting jewelry, coins, and other valuable items. In embodiments, this profile may prioritize features like Fine Gold Sensitivity for detecting small gold items, Coin Depth Indicator to estimate the burial depth of coins, and Jewelry Mode to fine-tune the user-reconfigurable metal detector 110's sensitivity to the conductivity levels typical of precious metals used in jewelry.

In embodiments, the different product profiles with which the user-reconfigurable metal detector 110 may be configured may include an industrial and commercial product profile configured for metal detecting operations for industrial and commercial applications. In embodiments, this profile may include features such as Pipeline Locator for identifying buried utility lines, Construction Material Discrimination to differentiate between various metal types used in construction, and Safety Check modes for ensuring compliance with metal-free zones in sensitive industrial environments, among others.

In embodiments, the different product profiles with which the user-reconfigurable metal detector 110 may be configured may include a gold hunting product profile that may be configured for detecting gold objects. This profile may include features such as a High-Frequency mode for enhanced sensitivity to small gold nuggets, Mineralization Filtering to counteract the effects of mineralized soils commonly found in gold-rich areas, a Gold Field Mode to adjust the metal detector's settings for optimum performance in known gold fields, etc.

It is noted that the product profiles (e.g., performance-based and/or application-based) described herein represent a non-limiting example of the functionality of the user-reconfigurable metal detector 110, and should not be construed as limiting in any way. Indeed, in embodiments, other product profiles may be provided.

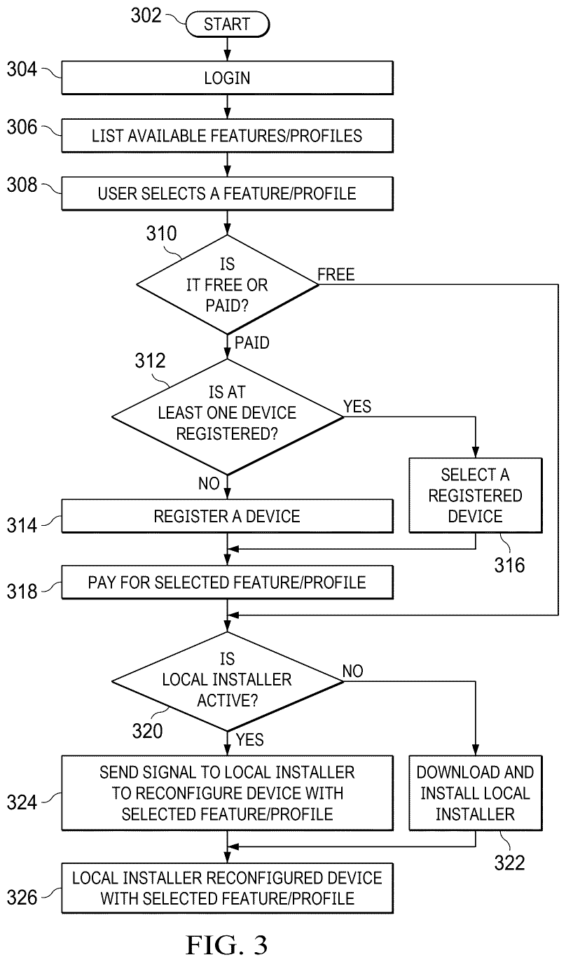

FIG. 3 shows a high-level flow diagram of operation of a system configured for providing functionality for managing reconfiguration of user-reconfigurable metal detectors in accordance with embodiments of the present disclosure. The operations depicted in the high-level flow diagram of FIG. 3 may outline the steps taken by a backend system (e.g., the backend system 150) to enable reconfiguration management functionality.

Operations may begin at block 302, and at block 304 a user interface is provided to enable a user to log into the backend system 150. This login step may be particularly important as it may establish the user's identity and may grant access to the functionality of the backend system 150. Once logged in, the backend system 150 may present, at block 306, a list of available features and/or product profiles, each tailored to enhance the capabilities of various models of metal detecting devices. The backend system 150 may enable the user to browse through this list, which may include advanced features like enhanced discrimination modes for specific metal types, or specialized product profiles that optimize the metal detector for applications such as underwater exploration or high-mineralization environments.

At block 308, a user selects one or more of the features in the set of the available feature associated with a metal detecting device, or may select a product profile from the product profiles available for the metal detecting device. The selection of the one or more features may include a selection to add at least one of selected features to the configuration of the metal detecting device, a selection to remove at least one of selected features from the configuration of the metal detecting device, a selection to enable at least one of selected features in the configuration of the metal detecting device, a selection to disable at least one of selected features in the configuration of the metal detecting device, a selection to upgrade at least one of selected features in the configuration of the metal detecting device to a higher level of performance, or a selection to downgrade at least one of selected features in the configuration of the metal detecting device to a lower level of performance. In embodiments, the selection of a product profile from the product profiles available for the metal detecting device may include a selection to install the selected product profile, including a set of features, on the metal detecting device, which may replace a current product profile of the metal detecting device.

At block 310, a determination is made as to whether the selected feature and/or product profile is free or requires purchase. In the case where the selected feature and/or product profile is free, or has been previously purchased, the operations proceed to block 320. However, in response to a determination that the selected feature and/or product profile is not free or has not been previously purchased, and requires payment, operations may proceed to block 312, where a determination is made as to whether at least one metal detecting device has been registered for the user. In response to a determination that no metal detecting device has been registered for the user, operations proceed to block 314, at which the user is prompted to register a device for installing the selected feature and/or product profile. In response to a determination that at least one metal detecting device has been registered for the user, at block 316, the list of registered metal detecting devices for the user is presented to the user and the user is prompted to select one of the registered metal detecting device for installing the selected feature and/or product profile.

At block 318, the user may be prompted to pay for the selected feature and/or product profile. At block 320, a determination is made as to whether a local installer is active and associated or connected to the selected metal detecting device for installing the selected feature and/or product profile. In response to a determination that a local installer is not active and associated or connected to the selected metal detecting device for installing the selected feature and/or product profile, the user may be promoted to download, install, and/or open the local installer and connect the selected metal detecting device for installing the selected feature and/or product profile to the local installer, at which point operations proceed to block 324. On the other hand, in response to a determination that a local installer is active and associated or connected to the selected metal detecting device for installing the selected feature and/or product profile, the backend server, at block 324, may send a reconfiguration signal to the local installer to reconfigure the metal detecting device to implement the selected feature and/or product profile to the local installer.

At block 326, the local installer may reconfigure the metal detecting device to implement the selected feature and/or product profile to the local installer in accordance with the functionality of the local installer.

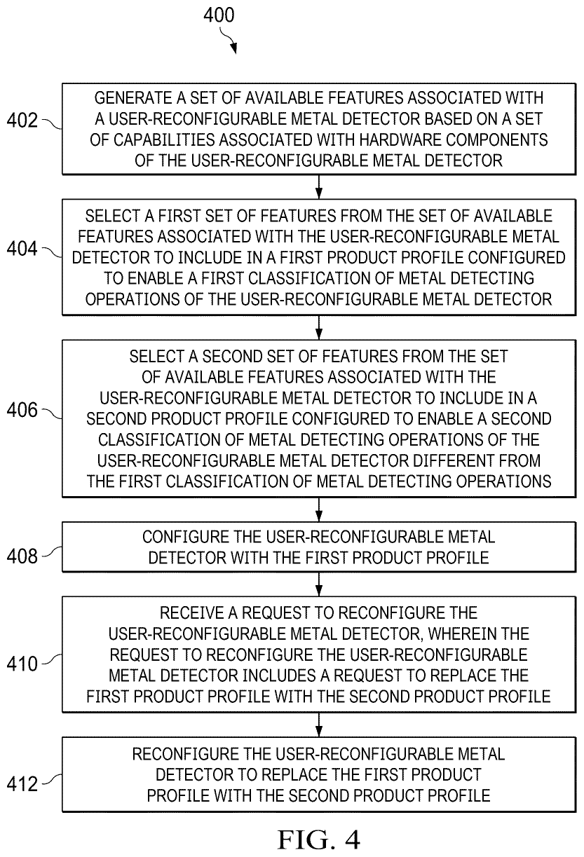

FIG. 4 shows a high-level flow diagram 400 of operation of a system configured for providing functionality for managing the reconfiguration of user-reconfigurable metal detectors in accordance with embodiments of the present disclosure. For example, the functions illustrated in the example blocks shown in FIG. 4 may be performed by system 100 of FIG. 1 according to embodiments herein. In embodiments, the operations of the method 400 may be stored as instructions that, when executed by one or more processors, cause the one or more processors to perform the operations of the method 400.

At block 402, a set of available features associated with a user-reconfigurable metal detector is generated based on a set of capabilities associated with hardware components of the user-reconfigurable metal detector. In embodiments, functionality of a backend system (e.g., backend system 150 as illustrated in FIG. 1) may be used to generate a set of available features associated with a user-reconfigurable metal detector based on a set of capabilities associated with hardware components of the user-reconfigurable metal detector. In embodiments, the backend system may perform operations to generate a set of available features associated with a user-reconfigurable metal detector based on a set of capabilities associated with hardware components of the user-reconfigurable metal detector according to operations and functionality as described above with reference to backend system 150 and as illustrated in FIGS. 1-3.

At block 404, a first set of features is selected from the set of available features associated with the user-reconfigurable metal detector to include in a first product profile configured to enable a first classification of metal detecting operations of the user-reconfigurable metal detector. In embodiments, functionality of an update system (e.g., update system 105 as illustrated in FIG. 1) may be used to select a first set of features from the set of available features associated with the user-reconfigurable metal detector to include in a first product profile configured to enable a first classification of metal detecting operations of the user-reconfigurable metal detector. In embodiments, the update system may perform operations to select a first set of features from the set of available features associated with the user-reconfigurable metal detector to include in a first product profile configured to enable a first classification of metal detecting operations of the user-reconfigurable metal detector according to operations and functionality as described above with reference to update system 105 and as illustrated in FIGS. 1-3.

At block 406, a second set of features is selected from the set of available features associated with the user-reconfigurable metal detector to include in a second product profile configured to enable a second classification of metal detecting operations of the user-reconfigurable metal detector different from the first classification of metal detecting operations. In embodiments, functionality of a update system (e.g., update system 105 as illustrated in FIG. 1) may be used to select a second set of features from the set of available features associated with the user-reconfigurable metal detector to include in a second product profile configured to enable a second classification of metal detecting operations of the user-reconfigurable metal detector different from the first classification of metal detecting operations. In embodiments, the update system may perform operations to select a second set of features from the set of available features associated with the user-reconfigurable metal detector to include in a second product profile configured to enable a second classification of metal detecting operations of the user-reconfigurable metal detector different from the first classification of metal detecting operations according to operations and functionality as described above with reference to update system 105 and as illustrated in FIGS. 1-3.

At block 408, the user-reconfigurable metal detector is configured with the first product profile. In embodiments, functionality of an update system (e.g., update system 105 as illustrated in FIG. 1) may be used to configure the user-reconfigurable metal detector with the first product profile. In embodiments, the update system may perform operations to configure the user-reconfigurable metal detector with the first product profile according to operations and functionality as described above with reference to update system 105 and as illustrated in FIGS. 1-3.

At block 410, a request to reconfigure the user-reconfigurable metal detector is received. In embodiments, the request to reconfigure the user-reconfigurable metal detector includes a request to replace the first product profile with the second product profile. In embodiments, functionality of an update system (e.g., update system 105 as illustrated in FIG. 1) may be used to receive a request to reconfigure the user-reconfigurable metal detector. In embodiments, the update system may perform operations to receive a request to reconfigure the user-reconfigurable metal detector according to operations and functionality as described above with reference to update system 105 and as illustrated in FIGS. 1-3.

At block 412, the user-reconfigurable metal detector is reconfigured to replace the first product profile with the second product profile. In embodiments, functionality of an update system (e.g., update system 105 as illustrated in FIG. 1) may be used to reconfigure the user-reconfigurable metal detector to replace the first product profile with the second product profile. In embodiments, the update system may perform operations to reconfigure the user-reconfigurable metal detector to replace the first product profile with the second product profile according to operations and functionality as described above with reference to update system 105 and as illustrated in FIGS. 1-3.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-4 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of managing reconfiguration of user-reconfigurable metal detectors, comprising:
generating a set of available features associated with a user-reconfigurable metal detector based on a set of capabilities associated with hardware components of the user-reconfigurable metal detector;
selecting a first set of features from the set of available features associated with the user-reconfigurable metal detector to include in a first product profile configured to enable a first classification of metal detecting operations of the user-reconfigurable metal detector;
selecting a second set of features from the set of available features associated with the user-reconfigurable metal detector to include in a second product profile configured to enable a second classification of metal detecting operations of the user-reconfigurable metal detector different from the first classification of metal detecting operations;
configuring the user-reconfigurable metal detector with the first product profile;
receiving a request to reconfigure the user-reconfigurable metal detector, wherein the request to reconfigure the user-reconfigurable metal detector includes a request to replace the first product profile with the second product profile, and
reconfiguring the user-reconfigurable metal detector to replace the first product profile with the second product profile.

2. The method of claim 1, wherein the second set of features included in the second product profile is different from the first set of features included in the first product profile in one or more of:
the second set of features includes one or more features of the first set of features configured to a higher level of performance in the second set of features;
the second set of features includes one or more features of the first set of features configured to a lower level of performance in the second set of features;
the second set of features includes one or more features that are not included in the first set of features;
the second set of features excludes one or more features that are included in the first set of features;
the second set of features includes one or more features that are enabled in the second set of features and disabled in the first set of features; and
the second set of features includes one or more features that are disabled in the second set of features and enabled in the first set of features.

3. The method of claim 1, wherein the first classification of metal detecting operations is based on a performance level of the user-reconfigurable metal detector, and wherein the second classification of metal detecting operations represents a different performance level achieved by the second product profile, the different performance level providing one of higher detection capabilities or lower detection capabilities compared to the first classification.

4. The method of claim 1, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

5. The method of claim 1, further comprising presenting a graphical user interface on a user terminal to facilitate the selection of the first set of features or the selection of the second set of features by a user.

6. The method of claim 1, wherein configuring the user-reconfigurable metal detector with the first product profile includes transmitting configuration data from a backend system to the user-reconfigurable metal detector via a local installer.

7. The method of claim 1, wherein reconfiguring the user-reconfigurable metal detector includes managing, by a local installer, a transfer and installation of the second product profile on the user-reconfigurable metal detector.

8. A system configured for managing reconfiguration of user-reconfigurable metal detectors, comprising:
at least one processor; and
a memory operably coupled to the at least one processor and storing processor-readable code that, when executed by the at least one processor, is configured to perform operations including:
generating a set of available features associated with a user-reconfigurable metal detector based on a set of capabilities associated with hardware components of the user-reconfigurable metal detector;
selecting a first set of features from the set of available features associated with the user-reconfigurable metal detector to include in a first product profile configured to enable a first classification of metal detecting operations of the user-reconfigurable metal detector;
selecting a second set of features from the set of available features associated with the user-reconfigurable metal detector to include in a second product profile configured to enable a second classification of metal detecting operations of the user-reconfigurable metal detector different from the first classification of metal detecting operations;
configuring the user-reconfigurable metal detector with the first product profile;
receiving a request to reconfigure the user-reconfigurable metal detector, wherein the request to reconfigure the user-reconfigurable metal detector includes a request to replace the first product profile with the second product profile, and
reconfiguring the user-reconfigurable metal detector to replace the first product profile with the second product profile.

9. The system of claim 8, wherein the second set of features included in the second product profile is different from the first set of features included in the first product profile in one or more of:
the second set of features includes one or more features of the first set of features configured to a higher level of performance in the second set of features;
the second set of features includes one or more features of the first set of features configured to a lower level of performance in the second set of features;
the second set of features includes one or more features that are not included in the first set of features;
the second set of features excludes one or more features that are included in the first set of features;
the second set of features includes one or more features that are enabled in the second set of features and disabled in the first set of features; and
the second set of features includes one or more features that are disabled in the second set of features and enabled in the first set of features.

10. The system of claim 8, wherein the first classification of metal detecting operations is based on a performance level of the user-reconfigurable metal detector, and wherein the second classification of metal detecting operations represents a different performance level achieved by the second product profile, the different performance level providing one of higher detection capabilities or lower detection capabilities compared to the first classification.

11. The system of claim 8, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

12. The system of claim 8, further comprising presenting a graphical user interface on a user terminal to facilitate the selection of the first set of features or the selection of the second set of features by a user.

13. The system of claim 8, wherein configuring the user-reconfigurable metal detector with the first product profile includes transmitting configuration data from a backend system to the user-reconfigurable metal detector via a local installer.

14. The system of claim 8, wherein reconfiguring the user-reconfigurable metal detector includes managing, by a local installer, a transfer and installation of the second product profile on the user-reconfigurable metal detector.

15. A computer-based tool for managing reconfiguration of user-reconfigurable metal detectors, the computer-based tool including non-transitory computer readable media having stored thereon computer code which, when executed by a processor, causes a computing device to perform operations comprising:
generating a set of available features associated with a user-reconfigurable metal detector based on a set of capabilities associated with hardware components of the user-reconfigurable metal detector;
selecting a first set of features from the set of available features associated with the user-reconfigurable metal detector to include in a first product profile configured to enable a first classification of metal detecting operations of the user-reconfigurable metal detector;
selecting a second set of features from the set of available features associated with the user-reconfigurable metal detector to include in a second product profile configured to enable a second classification of metal detecting operations of the user-reconfigurable metal detector different from the first classification of metal detecting operations;
configuring the user-reconfigurable metal detector with the first product profile;
receiving a request to reconfigure the user-reconfigurable metal detector, wherein the request to reconfigure the user-reconfigurable metal detector includes a request to replace the first product profile with the second product profile, and
reconfiguring the user-reconfigurable metal detector to replace the first product profile with the second product profile.

16. The computer-based tool of claim 15, wherein the second set of features included in the second product profile is different from the first set of features included in the first product profile in one or more of:
the second set of features includes one or more features of the first set of features configured to a higher level of performance in the second set of features;
the second set of features includes one or more features of the first set of features configured to a lower level of performance in the second set of features;
the second set of features includes one or more features that are not included in the first set of features;
the second set of features excludes one or more features that are included in the first set of features;
the second set of features includes one or more features that are enabled in the second set of features and disabled in the first set of features; and
the second set of features includes one or more features that are disabled in the second set of features and enabled in the first set of features.

17. The computer-based tool of claim 15, wherein the first classification of metal detecting operations is based on a performance level of the user-reconfigurable metal detector, and wherein the second classification of metal detecting operations represents a different performance level achieved by the second product profile, the different performance level providing one of higher detection capabilities or lower detection capabilities compared to the first classification.

18. The computer-based tool of claim 15, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

19. The computer-based tool of claim 15, further comprising presenting a graphical user interface on a user terminal to facilitate the selection of the first set of features or the selection of the second set of features by a user.

20. The computer-based tool of claim 15, wherein configuring the user-reconfigurable metal detector with the first product profile includes transmitting configuration data from a backend system to the user-reconfigurable metal detector via a local installer.
